(19) United States
(12) Patent Application Publication
(10) Pub. No.: US 2026/0059519 A1
(43) Pub. Date: Feb. 26, 2026

(54) NETWORK-BASED INTELLIGENT MULTICASTING FOR CELLULAR NETWORKS

(71) Applicant: Boost SubscriberCo L.L.C., Englewood, CO (US)

(72) Inventor: Rohit Singh, Littleton, CO (US)

(21) Appl. No.: 18/828,792

(22) Filed: Sep. 9, 2024

Related U.S. Application Data
(60) Provisional application No. 63/686,326, filed on Aug. 23, 2024.

(51) Int. Cl. H04W 72/121; H04W 72/232; H04W 72/30; H04W 72/542

(52) U.S. Cl. CPC H04W 72/121; H04W 72/232; H04W 72/30; H04W 72/542

(57) ABSTRACT

Systems and methods for network-based intelligent multicasting in cellular networks are disclosed. User Grouping Criteria (UGC) are generated for User Equipment (UEs) within a cell. The base station determines a group of UEs capable of device-to-device (D2D) communication that satisfy the UGC. Multicasting transmissions for the group are scheduled using D2D communication, facilitating direct communication without routing data through the base station. The UGC considers factors including UE capabilities, measurement reports, Channel Quality Indicators (CQI), locations, and directionality. Error management and retransmission protocols ensure reliable D2D communication. The system facilitates optimization of network resource utilization, reduces base station load, and improves spectral efficiency by utilizing D2D capabilities for multicasting in scenarios where multiple UEs are in close proximity.

### TECHNICAL FIELD

The present disclosure relates to wireless telecommunication networks, and specifically to systems and methods for network-based intelligent multicasting for cellular networks.

### BRIEF SUMMARY

In various example embodiments, systems and methods are disclosed for implementing network-based intelligent, directional multicasting for cellular networks, particularly in 5G and beyond. The systems and methods described herein address the limitations of current solutions that do not allow selective network-based multicasting in cellular networks or perform directional device-to-device multicasting based on user location, type, and demand.

In an example embodiment, the systems and methods described herein leverage device-to-device (D2D) communication, such as sidelink technology, to facilitate direct communication between User Equipment (UEs) without routing data through the base station (e.g., gNB). Such techniques improve spectral efficiency, reduces the load on the gNB, and aids in improving latency, thus, improving the end user experience.

In an example embodiment, the method involves the gNB generating a User Grouping Criteria (UGC) based on various factors including UE capabilities, measurement reports, Channel Quality Indicators (CQI), UE locations, and directionality. A new Information Element (IE) in UE capability information is introduced to identify UEs capable of D2D communication, such as sidelink communication.

Based on the UGC, the gNB determines groups of UEs that can communicate directly with each other, without the need for relaying the data packets to the gNB. The gNB then schedules “multicast transmissions” for these groups, i.e., reserves spectrum resources for the group of UE to communicate without injecting interference from other UEs. This type of scheduling will leverage device-to-device (D2D) communication, which may use a Downlink Control Information (DCI) format, such as the sidelink DCI format (i.e., Format 3_0).

The systems and methods described herein may also implement error management and retransmission protocols to ensure reliable communication. For instance, UEs with poor channel conditions (e.g., channel quality information (CQI) < 5) may be scheduled with multicast transmissions multiple times.

By enabling direct communication between nearby UEs using the uplink spectrum, the systems and methods described herein improve overall network efficiency, reduce latency, and help to optimize resource utilization in cellular networks. Example embodiments are particularly beneficial in scenarios such as communication within an office area or auditorium, where multiple users are in close proximity. The use-case can also be extended to vehicle-to-vehicle (V2V), and vehicle-to-pedestrian (V2P) type communications.

### BRIEF DESCRIPTION OF THE DRAWINGS

FIG. 1 is a diagram that illustrates an example system for network-based intelligent, directional multicasting in cellular networks, according to various embodiments described herein.

FIG. 2 is a chart illustrating grouping of UEs based on various User Grouping Criteria (UGC) components, according to various embodiments described herein.

FIG. 3 is a flowchart illustrating a method for network-based intelligent, directional multicasting for cellular networks, according to various embodiments described herein.

FIG. 4 is a flowchart illustrating a method for determining a group of UEs for multicasting, according to various embodiments described herein.

FIG. 5 is a flowchart illustrating a method for scheduling multicasting transmissions and implementing error management, according to various embodiments described herein.

FIG. 6 is a flowchart illustrating a method for implementing error management in multicasting transmissions in the method of FIG. 5, according to various embodiments described herein.

FIG. 7 is a system diagram that illustrates an example implementation of computing system(s) for implementing embodiments described herein.

### DETAILED DESCRIPTION

The following description, along with the accompanying drawings, sets forth certain specific details in order to provide a thorough understanding of various disclosed embodiments. However, one skilled in the relevant art will recognize that the disclosed embodiments may be practiced in various combinations, without one or more of these specific details, or with other methods, components, devices, materials, etc. In other instances, well-known structures or components that are associated with the environment of the present disclosure, including but not limited to the communication systems and networks, have not been shown or described in order to avoid unnecessarily obscuring descriptions of the embodiments. Additionally, the various embodiments may be methods, systems, media, or devices. Accordingly, the various embodiments may be entirely hardware embodiments, entirely software embodiments, or embodiments combining software and hardware aspects.

Throughout the specification, claims, and drawings, the following terms take the meaning explicitly associated herein, unless the context clearly dictates otherwise. The term “herein” refers to the specification, claims, and drawings associated with the current application. The phrases “in one embodiment,” “in another embodiment,” “in various embodiments,” “in some embodiments,” “in other embodiments,” and other variations thereof refer to one or more features, structures, functions, limitations, or characteristics of the present disclosure, and are not limited to the same or different embodiments unless the context clearly dictates otherwise. As used herein, the term “or” is an inclusive “or” operator, and is equivalent to the phrases “A or B, or both” or “A or B or C, or any combination thereof,” and lists with additional elements are similarly treated. The term “based on” is not exclusive and allows for being based on additional features, functions, aspects, or limitations not described, unless the context clearly dictates otherwise. In addition, throughout the specification, the meaning of “a,” “an,” and “the” include singular and plural references.

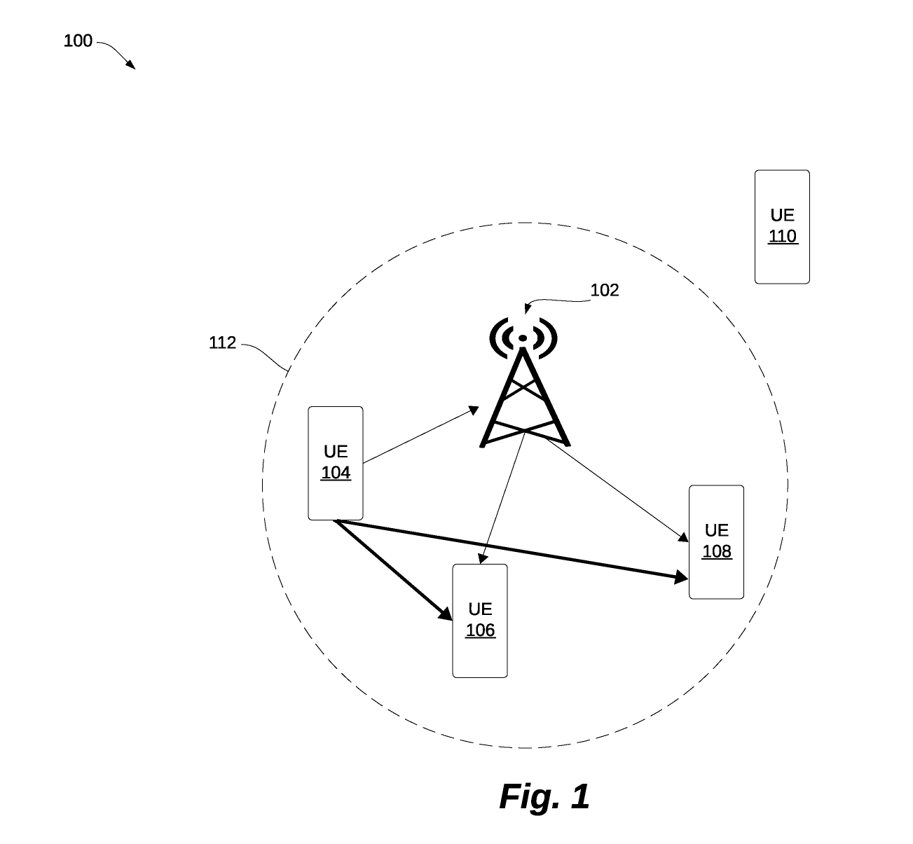

FIG. 1 illustrates an example system 100 for network-based intelligent, directional multicasting in cellular networks, according to various embodiments described herein. Multicast data submission is one-to-many (i.e., point-to-multipoint) or many-to-many (i.e., multipoint-to-multipoint). The system 100 includes a Next Generation Node B (gNB) 102, which is a Fifth Generation (5G) base station that serves as the central node for facilitating network-based intelligent multicasting for cellular networks.

In particular, in the example embodiment, the gNB 102 communicates with multiple User Equipment (UEs) including UE 104, UE 106, UE 108, and UE 110 within its coverage area. The gNB 102 is a component of a 5G network, providing radio access and managing radio resources for UEs within its coverage area. There may be fewer or additional UEs on the coverage area at any given time and in various different embodiments. The gNB 102 handles tasks such as radio transmission and reception, mobility management, and scheduling of network resources. In the present example embodiment, the gNB 102 determines User Grouping Criteria (UGC) and facilitates direct device-to-device (D2D) communication between UEs, for example D2D multicasting from UE 104 to a plurality of other UEs in the cell. D2D communication in a 5G network enables UEs to communicate directly with each other without routing data through the base station (e.g., gNB) or core network. This direct link between UEs in close proximity can utilize either licensed cellular spectrum (in-band) or unlicensed spectrum (out-of-band), offering flexibility in deployment. Although unlicensed bands have their own disadvantages of interference and coexistence with other unlicensed spectrum users, this form of transmission helps free up spectrum resources at the gNB layer in highly-congested scenarios, like airports or stadiums, in a controlled manner with gNB oversight. Moreover, using un-licensed spectrum for this type of multicast transmission will open end-users to utilize more bandwidth and gain higher throughput, which would have been difficult if the users were on the cellular network. Furthermore, within licensed spectrum, the multicast transmission allows networks to load-balance users and off-load these users to low-congested bands, like FR1 mid-band (sub-6 GHz) and FR2 (mmWaves) spectrum.

While D2D enables direct communication, the 5G network still maintains oversight, controlling resource allocation and connection establishment. This significantly reduces communication latency by eliminating the need to route data through the base station. Additionally, it improves spectral efficiency by allowing for the reuse of cellular resources and often requires less transmission power, leading to improved battery life for UEs. For example, in a setting like V2X, where there can be a group of UEs that need to communicate with each other and are either far from the gNB (i.e., at the edge cell) or are at a poor signal conditions (due to obstructions or unreliable radio-frequency (RF) channel due to mobility), can leverage multicast transmission and avoid transmissions via the gNB, which can increase latency and frequent data packet losses.

D2D communication, often referred to as “sidelink” in 5G, helps increase overall network capacity by offloading traffic from the cellular infrastructure. It is especially useful for proximity-based services, vehicle-to-vehicle communication, and public safety communications. Sidelink in 5G networks is defined by the Third Generation Partnership Project (3GPP) standards, such as 3GPP Release 17. 5G sidelink utilizes a modified protocol stack, with physical and MAC layers specifically designed for direct communication, while the Radio Link Control (RLC), Packet Data Convergence Protocol (PDCP), and Radio Resource Control (RRC) layers are adapted to support sidelink operations.

5G sidelink employs two modes of resource allocation including Mode 1, where the base station (gNB) schedules the sidelink resources, and Mode 2, where UEs select resources autonomously. In Mode 1, the gNB provides sidelink grants via downlink control information (DCI), while in Mode 2, UEs use sensing-based semi-persistent scheduling to select resources. In an example embodiment, the proposed method uses a hybrid-mode, where the gNB schedules the side-link resources with a feedback from the users and selects the UGC.

Sidelink utilizes physical channels, including the Physical Sidelink Control Channel (PSCCH) for carrying Sidelink Control Information (SCI), the Physical Sidelink Shared Channel (PSSCH) for user data and some control information, and the Physical Sidelink Feedback Channel (PSFCH) for Hybrid Automatic Repeat request (HARQ) feedback. Synchronization is achieved through specific signals like the Sidelink Synchronization Signal (SLSS), Sidelink Primary Synchronization Signal (S-PSS), and Sidelink Secondary Synchronization Signal (S-SSS), allowing UEs to synchronize even out of network coverage.

UEs, such as UE 104, UE 06, UE 108 and UE 110, may use sidelink discovery procedures to find nearby devices capable of D2D communication, broadcasting and receiving discovery messages on predefined resources. The technology supports various Modulation and Coding Schemes (MCS) including Quadrature Phase Shift Keying (QPSK), 16- Quadrature Amplitude Modulation (QAM), 64-QAM, and 256-QAM, using low-density parity-check (LDPC) coding for data and polar coding for control information. It employs a single-carrier frequency-division multiple access (SC-FDMA) scheme for multiple access, similar to the cellular uplink.

Error correction is managed through a HARQ process, supporting both synchronous and asynchronous operations. Power control is implemented using an open-loop system, where UEs adjust their transmission power based on pathloss estimates and predefined parameters.

5G sidelink D2D communication supports advanced features like carrier aggregation for increased data rates, beamforming in higher frequency bands to improve signal quality and range, and incorporates security measures at the PDCP layer. It also supports multiple Quality of Service (QoS) levels, allowing prioritization of different types of traffic. Sidelink integrates with 5G network slicing, enabling dedicated resources for specific use cases like vehicle-to-everything (V2X) communication. Furthermore, it supports UE-to-Network and UE-to-UE relay functionalities, extending network coverage and improving connectivity.

In 5G networks, D2D can operate in network-covered areas (network-assisted D2D, such as in the present example embodiment) or outside network coverage (autonomous D2D). The technology incorporates advanced security measures to ensure the integrity and confidentiality of direct communications. Furthermore, D2D in 5G is designed to support a large number of devices, aligning with the massive machine-type communications (mMTC) aspect of 5G.

UE 104, UE 106, UE 108, and UE 110 represent various devices capable of connecting to the 5G network, such as smartphones, tablets, or IoT devices. In the present example embodiment, some of these UEs may be equipped with D2D communication capabilities, for example, the sidelink technology described above, which allows them to communicate directly with each other without routing data through the gNB 102.

The dashed line 112 represents the UGC determined by the gNB 102. UE 104, UE 106, and UE 108 are grouped together based on this criteria, while UE 110 is not included in the group.

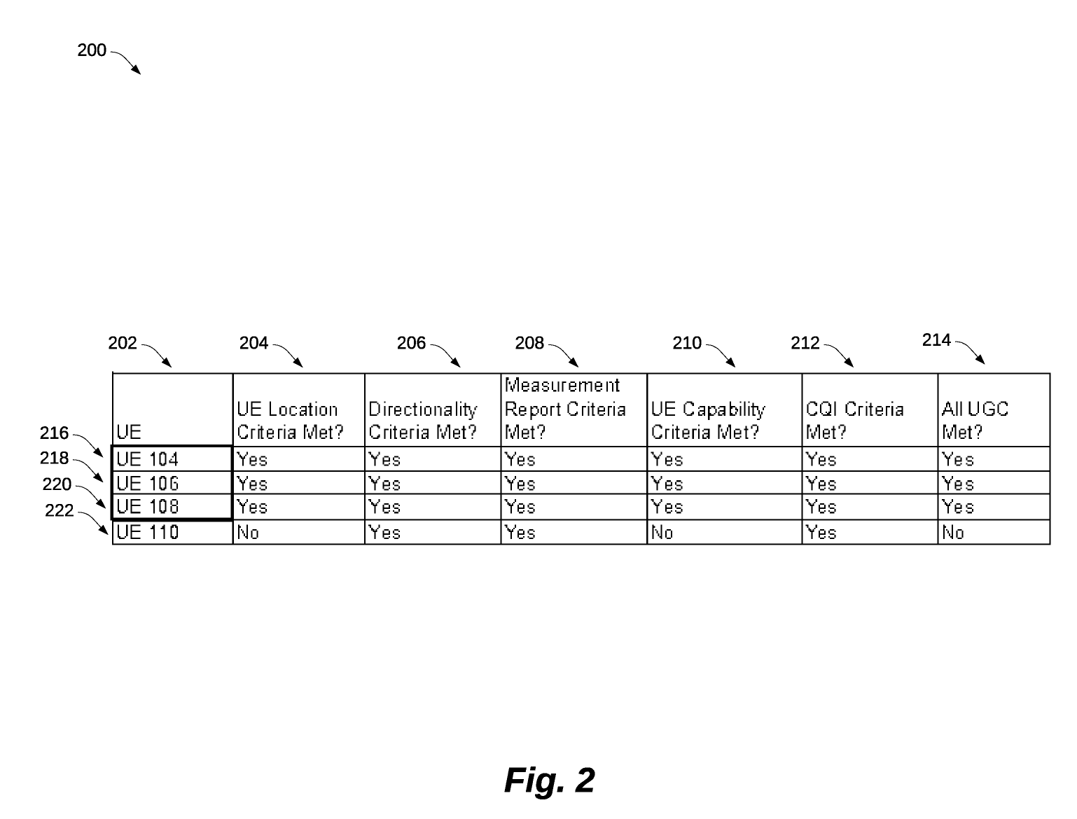

FIG. 2 is a chart 200 illustrating grouping of UEs based on various User Grouping Criteria (UGC) components, according to various embodiments described herein. The chart 200 includes columns for each UE 202, “UE Location Criteria Met?” 204, “Directionality Criteria Met?” 206, “Measurement Report Criteria Met?” 208, “UE Capability Criteria Met?” 210, “CQI Criteria Met?” 212, and “All UGC Met?” 214. The chart 200 includes an example of determinations that may be made by the base station (e.g., gNB 102 of FIG. 1) regarding whether the UEs of FIG. 1 meet UGC criteria for multicasting via D2D communications between such UEs.

For example, the location criteria may be that the UE must be within a particular distance from the UE sending the multicast data in order to receive the data via a D2D communication. If the UE is outside that range, then the gNB 102 may determine that the UE location criteria has not been met for that UE. For example, the gNB can leverage positioning reference signal (PRS) in the downlink and the sounding reference signal (SRS) in the uplink to precisely locate the user in both outdoor and indoor scenarios.

As another example, directionality criteria may be that the UE must be is a position such that it will reliably receive transmissions originating from a particular location. If the UE is not a position such that it will reliably receive transmissions originating from that particular location, then the gNB 102 may determine that the directionality criteria has not been met for that UE. UEs might not have the capability to do directional communication, which doesn’t disqualify the UE from multicast transmission; however, this criteria allows gNB to make efficient decision while scheduling users.

Regarding the measurement report criteria, measurements are facilitate determining the health of a cellular system given the current configuration. Measurements help the UE and the network make decisions so that resources are managed better and ultimately quality of service is achieved. Measurements are done by both UE and the network. Typically, a UE measures downlink signals while the network measures uplink signals. However, it's possible for a UE to measure uplink signals sent by other UEs. In an example embodiment, the gNB 102 may receive measurement reports regarding such measurements and determine whether such measured conditions are such that the applicable UE can participate in D2D multicast messaging. If the gNB 102 determines such measured conditions indicate that the applicable UE cannot participate in D2D multicast messaging based on the measurement reports, then the gNB 102 may determine that the measurement report criteria has not been met for that UE.

In an example embodiment, the gNB may determine whether the UE capability criteria is met based on capability information received from the UE that includes an Information Element (IE) indicating whether there exists D2D communication capability of the UE. Furthermore, other information in the UE Capability information can be used to identify what spectrum bands, MIMO layers, and CA combinations the UE can utilize for a multicast transmission. Hence impacting the performance of the multicast transmission.

In an example embodiment, the gNB may determine whether the UE CQI criteria is met based on the CQI-ReportCofig specified by higher layer message (e.g, RRC Connection Reconfiguration, RRC Connection Setup). The CQI criteria is critical to understand the signal-to-interference-noise ratio (SINR), which is important for determining the feasibility of direct communication between UEs. Moreover, the based on the CIQ the gNB can help identify the MCS, which will be required to be used between the UEs during the multicast transmission.

Based on the criteria in 204, 206, 208, 210, & 212 the UGC criteria in Column 214. The 214 criteria is a weighted sum of the other criteriaD, which offers flexibility in deployment based and can be dynamically changed based on the needs of the network.

Rows 216, 218, 220, and 222 represent UEs 104, 106, 108, and 110, respectively. UEs 104, 106, and 108 (rows 216, 218, and 220) are shown to meet all the criteria, with “Yes” marked in each column, indicating that they meet all UGC components and are thus grouped together for multicasting via D2D communications between such UEs.

Row 222, representing UE 110, shows that it does not meet the Location criteria (marked "No" in column 204) and does not meet the UE Capability criteria (marked "No" in column 210). Consequently, the “All UGC Met?” 214 is marked "No" for UE 110, indicating that it is not included in the multicasting group. The gNB 102 of FIG. 1 will then schedule the multicast transmissions for UEs 104, 106, 108, such as a multicast message from UE 104 to UEs 06 and 108 as shown in FIG. 1.

This detailed breakdown of UGC components allows the gNB to make precise decisions about which UEs can participate in direct, multicast communications. It considers not only the physical aspects like location and directionality but also the technical capabilities of the UEs and the quality of their connections to the network. In some embodiments, the chart 200 may represent a data structure electronically maintained by gNB 102 or other system component that tracks whether various UEs meet such criteria and may be dynamically updated as conditions of the network and UEs change, including when new UEs appear on the network and UEs leave the network.

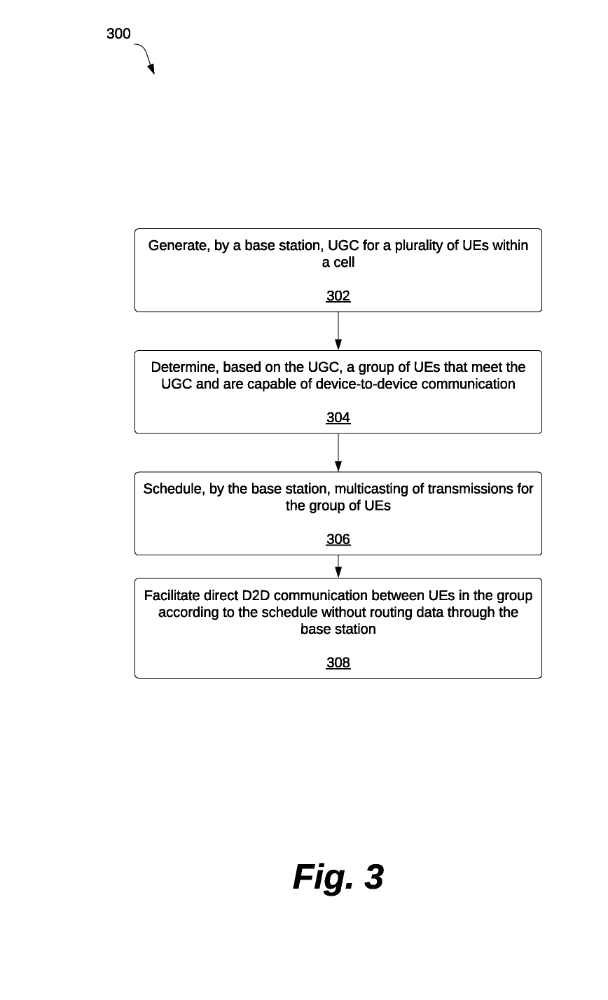

FIG. 3 is a flowchart illustrating a method 300 for network-based intelligent, directional multicasting in cellular networks, according to various embodiments described herein.

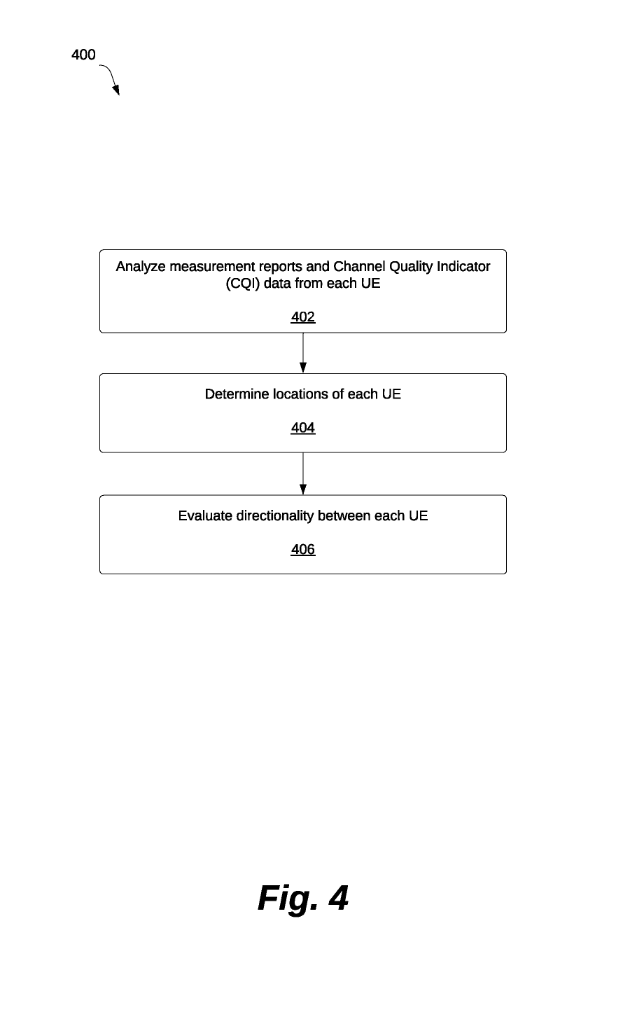

At 302, the base station (e.g., gNB 102) generates UGC for a plurality of UEs within its cell. This UGC may be based on various factors such as UE capabilities, UE location, measurement reports, and network conditions, which will be described in further detail below and in reference to FIG. 4.

At 304, the base station determines, based on the UGC, a group of UEs from the plurality of UEs that meet the UGC and are capable of device-to-device communication. This step may involve analyzing the capabilities and conditions of each UE to identify which ones can participate in direct communication. For example, the base station may receive capability information from each UE in the plurality of UEs. The capability information may include an Information Element (IE) indicating whether there exists D2D communication capability of the UE. An IE is a group of information which may be included within a signaling message or data flow which is sent across an interface. Examples may include QoS (Quality of Service) definitions, setup parameters, user identifiers etc. In the present embodiment, a novel IE is generated that indicates whether there exists D2D communication capability of the UE.

At 306, the base station may schedule multicast transmissions for the group of UEs in which the multicasting transmissions use device-to-device (D2D) communication. For example, this may include communication using sidelink technology. Sidelink technology, introduced in 3GPP Release 14 and enhanced in subsequent releases, allows direct communication between UEs without the need for data to pass through the network infrastructure. This technology is particularly useful for scenarios like vehicle-to-vehicle communication and, in the present example, for efficient multicasting in close proximity situations. However, other D2D communication technologies may be utilized in various different embodiments. The gNB can use the PSCCH to carry the SCI, which will inform the UEs of the scheduling for PSSCH. The scheduling may include determining transmission times and transmitting in a manner that, such that the scheduled transmissions do not interference with other transmissions of the base station for cellular communications of other UEs.

At 308, the base station facilitates the direct communication between UEs in the group according to the scheduling without routing data through the base station. This operation may utilize the sidelink capabilities of the UEs to establish direct communication channels through the PSSCH channel between the UEs.

FIG. 4 is a flowchart illustrating a method 400 for determining, based on the UGC, a group of UEs for multicasting, according to various embodiments described herein. For example, the method 400 may be used in method 300 of FIG. 3 for determining, based on the UGC, a group of UEs for multicasting.

At 402, the base station (e.g., gNB 102) analyzes measurement reports and Channel Quality Indicator (CQI) data from each UE in the plurality of UEs. CQI is a measure of the quality of the communication channel between the UE and the base station (e.g., gNB). The CQI is a 4-bit value that indicates the highest modulation and code rate for a received transport block that meets a block error rate target of at most 10% (as estimated by the UE). For example, the CQI may indicate there is an issue with the signal-to-noise ratio, which is important for determining the feasibility of direct communication between UEs.

At 404, the base station determines the locations of each UE in the plurality of UEs. This information is used to assess the proximity of UEs to each other, which is a factor in determining the feasibility of direct D2D communication.

At 406, the base station evaluates the directionality between each UE in the plurality of UEs. This operation considers the relative positions and orientations of the UEs to determine efficient communication paths. In particular, 5G broadcasts are directional. Instead of transmitting the same signal strength in every direction, specific locations may be targeted. The high frequencies of 5G services are less likely to be interrupted by other signals. Multiple wireless signals can be used alongside 5G without causing interference. The directionality of the signal reinforces that clarity, so data will get to its target safely. The directionality enables targeted coverage that concentrates on individual equipment or small geographical areas.

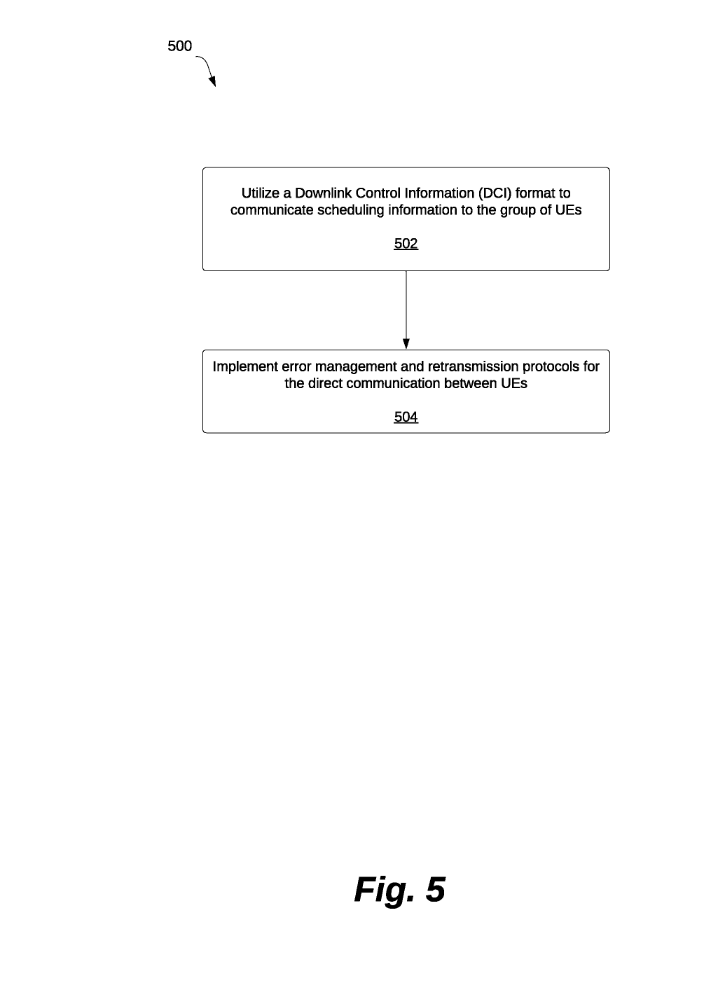

FIG. 5 is a flowchart illustrating a method 500 for scheduling multicasting transmissions and implementing error management, according to various embodiments described herein.

At 502, the base station (e.g., gNB 102) utilizing a Downlink Control Information (DCI) format to communicate scheduling information to the group of UEs. In some embodiments, the base station may use a Sidelink DCI format to communicate scheduling information to the group of UEs. DCI is a component of 5G networks used to convey control information from the gNB to UEs. In the present example embodiment, it is adapted or extended to include information specific to the multicasting schedule.

At 504, the base station implements error management and retransmission protocols for the direct D2D communication between UEs. This operation helps to ensure the reliability of the direct communication, addressing potential issues that may arise due to interference or poor channel conditions.

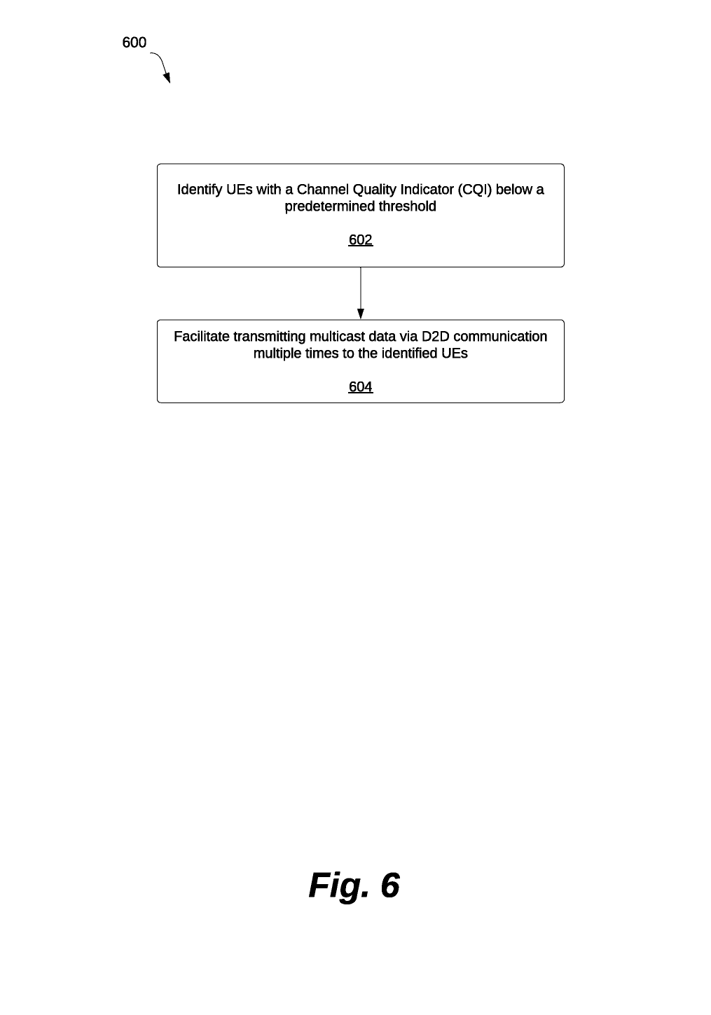

FIG. 6 is a flowchart illustrating a method 600 for implementing error management in multicasting transmissions, according to various embodiments described herein.

At 602, the base station (e.g., gNB 102) identifies UEs with a Channel Quality Indicator (CQI) below a predetermined threshold (e.g., below a threshold of 5). This operation facilitates identifying UEs that may have difficulty receiving transmissions reliably.

At 604, the base station facilitates transmitting multicast data multiple times to the identified UEs. This redundancy helps to ensure that UEs with poor channel conditions still receive the multicast data successfully.

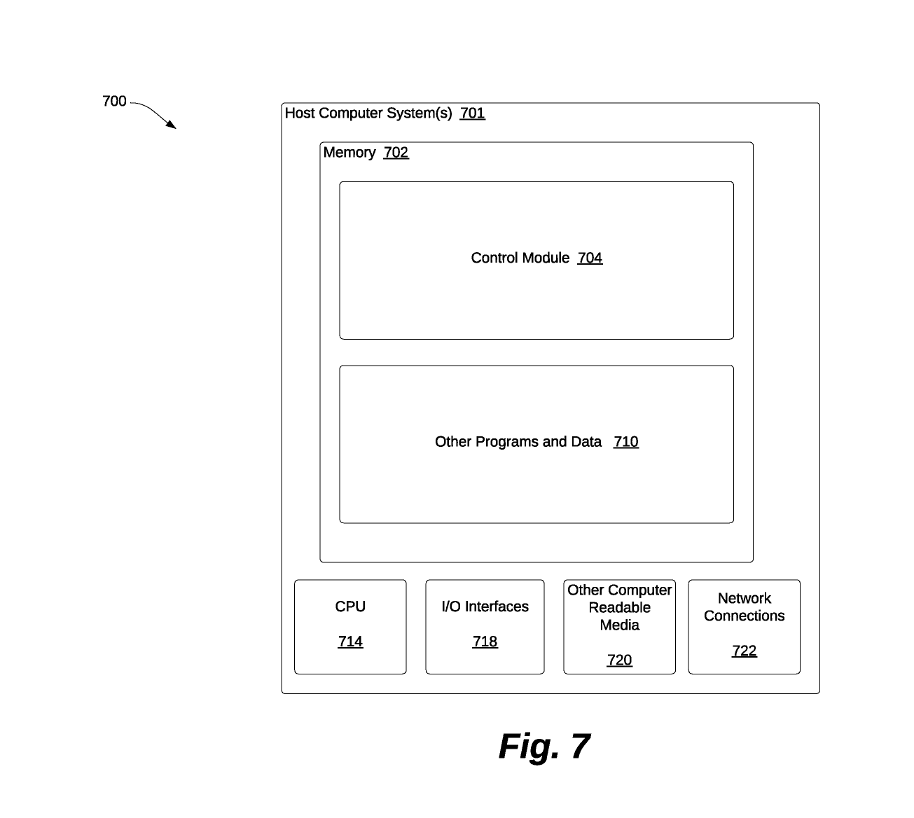

FIG. 7 shows a system diagram that describes an example implementation of computing system(s) 700 for implementing embodiments described herein.

The functionality described herein for systems and methods for network-based intelligent, directional multicasting can be implemented either on dedicated hardware, as a software instance running on dedicated hardware, or as a virtualized function instantiated on an appropriate platform, e.g., a cloud infrastructure. In some embodiments, such functionality may be completely software-based and designed as cloud-native, meaning that they're agnostic to the underlying cloud infrastructure, allowing higher deployment agility and flexibility. However, FIG. 7 illustrates an example of underlying hardware on which such software and functionality may be hosted and/or implemented.

In particular, shown is example host computer system(s) 701. For example, such computer system(s) 701 may represent those in various base stations, data centers, servers, network nodes, or other devices that are components of, or that host or implement the functions of, aspects described herein to implement systems and methods for network-based intelligent, directional multicasting in cellular networks. In some embodiments, one or more special-purpose computing systems may be used to implement the functionality described herein. Accordingly, various embodiments described herein may be implemented in software, hardware, firmware, or in some combination thereof. Host computer system(s) 701 may include memory 702, one or more central processing units (CPUs) 714, I/O interfaces 718, other computer-readable media 720, and network connections 722.

Memory 702 may include one or more various types of non-volatile and/or volatile storage technologies. Examples of memory 702 may include, but are not limited to, flash memory, hard disk drives, optical drives, solid-state drives, various types of random access memory (RAM), various types of read-only memory (ROM), other computer-readable storage media (also referred to as processor-readable storage media), or the like, or any combination thereof. Memory 702 may be utilized to store information, including computer-readable instructions that are utilized by CPU 714 to perform actions, including those of embodiments described herein.

Memory 702 may have stored thereon control module(s) 704. The control module(s) 704 may be configured to implement and/or perform some or all of the functions of the systems, components and modules described herein to implement systems and methods for network-based intelligent, directional multicasting in cellular networks. Memory 702 may also store other programs and data 710, which may include rules, databases, application programming interfaces (APIs), software platforms, cloud computing service software, intelligence layer software, network management software, network orchestrator software, network functions (NF), artificial intelligence (AI) or machine learning (ML) programs or models to perform the functionality described herein, user interfaces, operating systems, other network management functions, other NFs, etc.

Network connections 722 are configured to communicate with other computing devices to facilitate the functionality described herein. In various embodiments, the network connections 722 include transmitters and receivers (not illustrated), cellular telecommunication network equipment and interfaces, and/or other computer network equipment and interfaces to send and receive data as described herein, such as to send and receive instructions, commands and data to implement the processes described herein. I/O interfaces 718 may include various data input or output interfaces, or the like. Other computer-readable media 720 may include other types of stationary or removable computer-readable media, such as removable flash drives, external hard drives, or the like.

The various embodiments described above can be combined to provide further embodiments. These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

WHAT IS CLAIMED IS:

1. A method for network-based intelligent multicasting in cellular networks, the method comprising:
generating, by a base station, User Grouping Criteria (UGC) for a plurality of User Equipment (UEs) within a cell;
determining, based on the UGC, a group of UEs from the plurality of UEs that meet the UGC and are capable of device-to-device communication;
scheduling, by the base station, multicasting of transmissions for the group of UEs, the multicasting transmissions using device-to-device (D2D) communication; and
facilitating direct D2D communication between UEs in the group according to the scheduling without routing data through the base station.

2. The method of claim 1, wherein the determining the group of UEs includes:
receiving capability information from each UE in the plurality of UEs, the capability information including an Information Element (IE) indicating whether there exists D2D communication capability of the UE.

3. The method of claim 1, wherein determining the group of UEs includes:
analyzing measurement reports and Channel Quality Indicator (CQI) data from each UE in the plurality of UEs;
determining locations of each UE in the plurality of UEs; and
evaluating directionality between each UE in the plurality UEs.

4. The method of claim 1, wherein scheduling the multicasting transmissions includes:
utilizing a Downlink Control Information (DCI) format to communicate scheduling information to the group of UEs.

5. The method of claim 1, further comprising:
implementing error management and retransmission protocols for the direct D2D communication between UEs.

6. The method of claim 5, wherein implementing error management includes:
identifying UEs with a Channel Quality Indicator (CQI) below a predetermined threshold; and
facilitating transmitting multicast data via D2D communication multiple times to the identified UEs.

7. The method of claim 1, wherein facilitating direct D2D communication includes:
utilizing uplink spectrum for D2D communication between UEs in the group.

8. A system for network-based intelligent multicasting in cellular networks, the system comprising:
at least one processor; and
at least one memory coupled to the at least one processor, wherein the
at least one memory has computer-executable instructions stored thereon that, when executed by the at least one processor, cause the at least one processor to perform operations, the operations including:
generating, by a base station, User Grouping Criteria (UGC) for a plurality of User Equipment (UEs) within a cell;
determining, based on the UGC, a group of UEs from the plurality of UEs that meet the UGC and are capable of device-to-device communication;
scheduling, by the base station, multicasting of transmissions for the group of UEs, the multicasting transmissions using device-to-device (D2D) communication; and
facilitating direct D2D communication between UEs in the group according to the scheduling without routing data through the base station.

9. The system of claim 8, wherein the determining the group of UEs includes:
receiving capability information from each UE in the plurality of UEs, the capability information including an Information Element (IE) indicating whether there exists D2D communication capability of the UE.

10. The system of claim 8, wherein the operations further include:
analyzing measurement reports and Channel Quality Indicator (CQI) data from each UE in the plurality of UEs;
determining locations of each UE in the plurality of UEs; and evaluating directionality between each UE in the plurality of UEs.

11. The system of claim 8, wherein the scheduling multicasting transmissions includes:
utilizing a Downlink Control Information (DCI) format to communicate scheduling information to the group of UEs.

12. The system of claim 8, wherein the operations further include
implementing error management and retransmission protocols for the direct D2D communication between UEs.

13. The system of claim 12, wherein the implementing error management includes:
identifying UEs with a Channel Quality Indicator (CQI) below a predetermined threshold; and
facilitating transmitting multicast data via D2D communication multiple times to the identified UEs.

14. The system of claim 8, wherein the facilitating direct D2D communication includes:
utilizing uplink spectrum for D2D communication between UEs in the group.

15. A non-transitory computer-readable storage medium having computer-executable instructions stored thereon that, when executed by at least one processor, cause operations to be performed, the operations including:
generating User Grouping Criteria (UGC) for a plurality of User Equipment (UEs) within a cell;
determining, based on the UGC, a group of UEs from the plurality of UEs that meet the UGC and are capable of device-to-device communication;
scheduling, by the base station, multicasting of transmissions for the group of UEs, the multicasting transmissions using device-to-device (D2D) communication; and
facilitating direct D2D communication between UEs in the group according to the scheduling without routing data through the base station.

16. The non-transitory computer-readable storage medium of claim 15, wherein the determining, the group of UEs includes:
receiving capability information from each UE in the plurality of UEs, the capability information including an Information Element (IE) indicating whether there exists D2D communication capability of the UE.

17. The non-transitory computer-readable storage medium of claim 15, wherein determining the group of UEs includes:
analyzing measurement reports and Channel Quality Indicator (CQI) data from each UE in the plurality of UEs;
determining locations of each UE in the plurality of UEs; and evaluating directionality between each UE in the plurality UEs.

18. The non-transitory computer-readable storage medium of claim 15, wherein scheduling the multicasting transmissions includes:
utilizing a Downlink Control Information (DCI) format to communicate scheduling information to the group of UEs.

19. The non-transitory computer-readable storage medium of claim 15, wherein the operations further include:
implementing error management and retransmission protocols for the direct D2D communication between UEs.

20. The non-transitory computer-readable storage medium of claim 19, wherein implementing error management includes:
identifying UEs with a Channel Quality Indicator (CQI) below a predetermined threshold; and
facilitating transmitting multicast data via D2D communication multiple times to the identified UEs.
